(19) United States
(12) Patent Application Publication
(10) Pub. No.: US 2026/0348915 A1
(43) Pub. Date: Nov. 5, 2026

(54) DEVICE FOR REDUCING FRICTION FORCES OF A MAGNETISING DEVICE

(71) Applicant: Rosen IP AG, Stans (CH)

(72) Inventors: Andrey Danilov, Lingen (DE); Michael Schulte, Meppen (DE)

(21) Appl. No.: 19/115,454

(22) PCT Filed: Sep. 27, 2023
(86) PCT No.: PCT/EP2023/076743

§ 371 Date: Mar. 26, 2025

(30) Foreign Application Priority Data
Sep. 28, 2022 (BE) BE2022/5774

(51) Int. Cl. G01N 27/9093; F16L 55/28; G01N 27/90; G01N 27/9013; G01N 27/904

(52) U.S. Cl. CPC G01N 27/9093; F16L 55/28; G01N 27/9006; G01N 27/902; G01N 27/904

(57) ABSTRACT

A device is provided for the non-destructive testing of pipelines. In order to prevent a magnetizing device from being damaged on the wall of the pipeline by attractive forces between the magnetizing device and the wall of the pipeline during the testing of pipelines, the device has a compensation unit which movably connects the support device to the magnetizing device via an adjustment unit. The adjustment unit is supported on the device via a power accumulator.

### CROSS REFERENCE

This application claims priority to PCT Application No. PCT/EP2023/076743, filed Sep. 27, 2023, which itself claims priority to Belgian Patent Application No. BE2022/5774, filed Sep. 28, 2022, the entireties of both of which are hereby incorporated by reference.

### FIELD OF THE INVENTION

The present invention relates to a device for the non-destructive testing of pipelines with at least one measuring unit for recording measured values of the pipeline, wherein the measuring unit has at least one magnet, in particular in the form of a permanent magnet, which is preferably arranged in a magnetizing device and which generates attractive forces between the magnetizing device and the wall of the pipeline if the device is used, wherein the magnetizing device is connected to a support device which supports the magnetizing device against the wall of the pipeline if the device is used, and wherein the device is adapted to move along the pipeline.

### BACKGROUND OF THE INVENTION

Examples of magnetic methods for inspecting pipelines include the MFL and EMAT methods. When inspecting a pipeline, but also a metallic storage tank, using MFL and EMAT methods, a stronger magnetization of the metallic wall must be generated. The MFL and EMAT methods are used to assess the quality of metallic walls and in particular to identify defects in the form of corrosion or cracks. In the inline method, sensors are moved through a pipeline to be inspected in order to draw conclusions about the quality of the inspected wall from the sensor data of the measuring unit. However, the inspection can also be carried out from the outside, and when inspecting storage tanks, the sensors can be guided along the inside and outside of the wall of the storage tank. If the following refers to pipelines or a pipe, the explanations should also be read accordingly for storage tanks.

In the MFL or magnetic flux leakage method (in English—magnetic flux leakage), a magnetic field is induced in the pipe wall. Material defects, such as corrosion or material erosion in a different form, can be detected by detecting the deviating magnetic field that partially emerges from the pipe wall using appropriate sensors. The magnetization of the pipe wall has a significant influence on the accuracy of the information. If the pipe wall is not sufficiently magnetized, anomalies cannot be detected. The EMAT method—Electro Magnetic Acoustic Transducer—is an ultrasonic testing technology in which ultrasonic waves are generated and received electromagnetically. In this method, a static or quasi-static magnetic field is generated with a magnet, which field superimposes alternating magnetic fields generated by a coil. An EMAT induces ultrasonic waves into a test object by magnetostriction, the strength of which depends on the magnetic field induced by the magnets. Here, too, the quality of the pipe testing is influenced by the strength of the magnetic field.

In most cases of non-destructive testing of pipelines, the respective magnetic field is generated in particular with one or more permanent magnets, which are a component of the device. However, the magnets lead to strong attractive forces on the wall. The device in which the magnet or magnets are located moves along the pipe wall with increased frictional forces due to the attractive forces.

Pipeline inspection devices are moved by internal transportation of the pipeline medium or on or by a crawler. This often becomes a challenge in pipelines with low internal pressure. Due to the high friction, the crawlers also have a higher energy consumption and a complex construction to be able to pull themselves and the device. Even when testing metallic walls from the outside, increased frictional resistance must be overcome because the magnets press the magnetizing device against the wall.

Friction reduction is often also desired in a gas pipe in order to achieve smooth running of the device. The device may come to a standstill due to increased friction. As a result, the pressure behind the device increases due to the continuous gas flow. If the pressure reaches a sufficient value, the device often continues at a suddenly very high speed. The speed can exceed a critical level at which a reliable measurement is no longer possible.

Friction reduction also plays a major role in portable testing devices and enables a significant improvement in user-friendliness.

In addition, the higher friction causes increased wear on the brushes of the yokes in a magnetizing device, which can lead to higher maintenance costs.

Friction reduction is also very important for other devices where magnetization of the pipe wall is required and high friction is not desirable.

Weaker magnets are used to reduce the friction of the device, but this leads to a deterioration of the measurement results.

Another option is to attach wheels to the brushes. An example of a device of this type can be found in the document DE 10 2007 058 043 A1. In this device, the magnetizing device is fixedly connected to a support roller as one version of a support device, although the magnetizing device is pivotally connected to the rest of the device. The low coefficient of friction of the rolling friction of the support roller greatly reduces the friction caused by adhesive forces. To allow the wheels to run freely, there is a gap between the wall and the brush of the yoke, but this greatly weakens the magnetic field.

Furthermore, a device for testing pipelines is known from the document U.S. Pat. No. 5,565,633 A. The device has a cylindrical device body to be arranged in the pipeline with a magnetizing device, wherein the device body is centered in a pipeline via spring-loaded support arms and is supported on an inner wall of the pipeline. The distance between the magnetizing device and the inner wall of the pipeline depends on the centering of the device body via the centering units. This is disadvantageous for a uniform magnetization of the pipeline and/or reliable detection of the magnetic field.

### BRIEF SUMMARY OF THE INVENTION

It is the object of the present invention to develop a device for friction reduction while maintaining the strength of the magnetic flux.

The object is achieved for a generic device in that the device has a compensation unit which movably connects the support device to the magnetizing device via an adjustment unit, wherein the adjustment unit is supported on the device via a power accumulator.

Preferably, the compensation unit is supported on the magnetizing device. The adjustment unit is preferably supported on the magnetizing device via a power accumulator. In particular, the magnetizing device comprises the measuring unit and the magnet.

The compensation unit makes it possible to support the magnetizing device in such a way that the magnetic force of the permanent magnet or magnets acts to a high degree on the wall of the pipeline during operation of the device, but the friction of the magnetizing device on the wall of the pipeline is at least reduced or, in the case of a small gap between the wall of the pipeline and the adjacent surface of the magnetizing device, avoided altogether. The adjustment unit is connected to the rest of the device, in particular to the magnetizing device, in such a way that it is supported via the power accumulator on another part of the device, in particular on the magnetizing device. The adjustment unit is a part of the compensation unit, and the compensation unit is a part of the device, in particular the magnetizing device. The compensation unit is used to at least partially or completely compensate for the attractive forces with which the permanent magnet or magnets are pulled onto the surface of the wall of the pipeline as the compensation unit generates a force component directed in the opposite direction to the magnetic force via the power accumulator and transmitting it to the wall of the pipeline on which it is supported.

While the support roller known from the prior art keeps the magnetizing device at a constant distance from the wall of the pipeline, the compensation unit allows the magnetizing device to continue to slide on the wall of the pipeline so that the magnetic force acting on it can be fully used for signal evaluation. If the magnetizing device approaches the wall, the compensation unit is pressed in. There is little or no gap between the brush and the wall, and at the same time an opposing force is generated by the compensation unit. The contact pressure with which the magnetizing device is held on the surface of the wall is reduced by the amount of counterforce generated by the compensation unit, so that frictional forces with which the magnetizing device slides over the wall of the pipeline are also reduced. The adjustment unit has the function of adjusting the support device in relation to the magnetizing device, in particular a distance between the support device and the magnetizing device, wherein a counterforce to the magnetic force acting on the magnetizing device is generated via the power accumulator.

The compensation unit can also compensate the magnetic force to such an extent that the magnetizing device is kept at a small distance from the wall of the pipeline. Since an adjustment unit movably connects the support device to the rest of the magnetizing device, relative movements between the rest of the magnetizing device and the support device are possible. For example, the support device supported on the wall of the pipeline can deflect if there are inwardly directed unevennesses on the wall, such as those caused by weld seams, without the magnetizing device itself being moved inwards. The signal quality of the measurement signal is thus fully maintained, especially in such critical ranges, or at least it does not drop to such an extent that the quality of the measurement performed in the affected range is restricted or becomes completely unsuitable.

One advantage of supporting the magnetizing device via a compensation unit is therefore that the distance at which the magnetizing device is held away from the wall of the pipeline does not necessarily always have to remain the same, but is variable and in particular can also be zero, because the support device is relatively movable in relation to the magnetizing device via the compensation unit.

In particular, the magnetizing device is connected to the rest of the device in a movable, in particular pivotable, manner. The support device supports the magnetizing device independently of the rest of the device, in particular independently of the distance between the rest of the device and the pipeline wall. The variable distance between the magnetizing device and the pipeline wall is therefore independent of the support and/or centering of the rest of the device on the pipeline wall, for example, via support arms, centering units, cups, discs or similar. The relative movement between the magnetizing device and the support device via the compensation unit and the adjustment unit is independent of the rest of the device, in particular of a distance between the rest of the device and the pipeline wall. For example, a relative movement between the magnetizing device and the support device can take place while the distance between the remaining device and the pipeline wall remains the same.

The compensation unit allows the device to move through the pipeline with a lower drive power. Due to the lower sliding friction forces in the area of the permanent magnets, the drive power required to move the device through the pipeline is reduced. The movement is also smoother. This applies in particular if the device is transported through the pipeline with a gaseous medium that only has a low flow velocity. The compensation unit can be fully depressed by the magnetic force while traveling through the pipeline, which reduces the stress on the compensation unit due to possible irregularities on the pipe wall, such as weld seams, dents and the like.

As the attractive force on the magnetizing device is reduced, the passage of irregular areas on the pipe wall, such as weld seams, dents, etc., is facilitated, making the device run more smoothly, reducing mechanical effects on the entire structure and also reducing distortions during measurements. Preferably, the strength of the pressure of the compensation unit is such that the magnetic attractive forces attract the magnetizing device to the wall without a gap and the adhesion of the magnetizing device to the wall of the pipeline is enabled, while at the same time as much magnetic attractive force as possible is compensated by the compensation unit.

The present solution makes it possible to reduce the friction of the device, in particular the magnetizing device that induces magnetization, while minimizing a disturbing influence on the magnetic flux.

According to one embodiment of the invention, the support device has at least one support roller. To reduce the friction between the compensation unit and the wall of the pipeline, one or more wheels can be mounted on the compensation unit so that the unit moves over the wall surface on at least one wheel. However, the support device can also consist of a treadmill, a caterpillar track or other rotating or revolving actively or passively driven elements that roll on the surface of the wall of the pipeline. However, the support device can also consist of one or more sliding elements with one or more sliding surfaces, which are passively guided in a sliding movement over the surface of the wall. In particular, the sliding surfaces can be made of a material with a low coefficient of sliding friction, such as PTFE or suitable elastomers.

According to one embodiment of the invention, a counterforce generated by the compensation unit via a power accumulator is variable. The counterforce generated in the power accumulator is variable if the adjustment unit, via which the support device is connected to the magnetizing device, is supported on a power accumulator that generates a counterforce of varying magnitude in different positions of the adjustment unit. Mechanical springs, for example, have different levels of restoring force depending on how far they are extended. Different pressure levels of a pneumatic cylinder also result in different restoring forces. An actuator can also be set to a different support force. With such changes, the counterforce acting on the magnetizing device from the compensation unit changes. With variable counterforces, this can be greater in particular the further the compensation unit deflects against the magnetizing device and the power accumulator used.

According to one embodiment of the invention, the compensation unit is supported by a mechanical spring as a power accumulator. When the compensation unit is pressed in, the spring generates a force that acts against the magnetic attractive forces on the wall. A mechanical spring, for example, whose spring characteristic curve shows an increasing force the further it is retracted or extended, can be considered as a power accumulator. The spring characteristic curve can be progressive, linear, degressive, very soft, preloaded or linear with a kink. With a spring as a power accumulator, advantageous restoring forces also build up during a spring movement, through which the adjustment unit is moved back to the initial position after a compression or retraction movement if the force impulse that caused a compression or retraction movement disappears. As a result, the adjustment unit is usually held in its normal position, in which a good desired support of the magnetizing device on the wall of the pipeline is achieved. The spring force of the mechanical spring is selected via the spring travel used in such a way that the magnetic force acting on the magnetizing device is at least partially compensated for in a deflected position of the compensation unit.

According to one embodiment of the invention, the compensation unit is supported by a pneumatic cylinder as a power accumulator. Pneumatic cylinders also allow the adjustment unit to be compressed and retracted via a gas bladder, wherein pneumatic cylinders also produce advantageous restoring forces during a compression or retraction movement. If the compensation unit is pneumatically spring-loaded, when the compensation unit is pressed into the pneumatic cylinder, a force is generated by the gas cushion inside, which acts as a counterforce against the magnetic attractive forces.

According to one embodiment of the invention, the compensation unit is supported by a support drive. Instead of mechanical springs or pneumatic cylinders, a support drive can also be used, which can be adjustable in its force effect. For example, electric motors, in particular in the form of servo-motors, with a variable counterforce can be used as a support drive, or other suitable motor-driven components with a variable counterforce generated by them can be used. In this way, a support drive is also a power accumulator that counteracts the magnetic force.

According to one embodiment of the invention, the counterforce generated by the compensation unit is adjustable. To adjust the counterforce, mechanical springs can be equipped with an adjustable tensioning device that can be used to pretension or relax the springs, resulting in a changed spring characteristic. In the same way, the counterforces generated by gas bubbles in pneumatic cylinders can be adjusted by feeding additional gas into the pneumatic cylinder or releasing it. The driving force of actuators can also be adjustable.

According to one embodiment of the invention, the compensation unit is connected to an electrical control unit via which the counterforce can be adjusted. The counterforce can be adapted to the force of the magnetic force in particular via the electrical control. For example, a Hall sensor can be used to measure the magnetic field, and based on the measured value, the spring force of the compensation unit is changed via a motorized system. Such an adjustment via the electrical control can be automated during operation of the device, for example, controlled by software that forms part of the electrical control.

According to one embodiment of the invention, a plurality of compensation units are arranged on a magnetizing device, wherein the support devices are arranged at a distance from one another in the direction of movement of the device. Since a magnetizing device extends over a certain length in the direction of movement of the device, it is advantageous to support the magnetizing device at several points that are spaced apart from one another. Advantageously, the magnetizing device is supported in its front part in the direction of movement and in the rear part, so that at least approximately equal support against the magnetic force is provided over its overall length.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a view of a device in a pipeline.

FIG. 1a is an enlarged view of the zone in which the magnetizing device with the measuring unit is located.

FIG. 2 is a view of a magnetizing device with a compensation unit.

FIGS. 3-14 illustrate further embodiments of the magnetizing device shown in FIG. 2 with differently designed compensation units.

### DETAILED DESCRIPTION OF THE DRAWINGS

Individual technical features of the objects described below can be the object of the invention if used alone, in combination with the features already described above and/or in combination with one another and can be advantageous to the invention. Identical or similar parts of the devices are marked with identical reference numbers where appropriate.

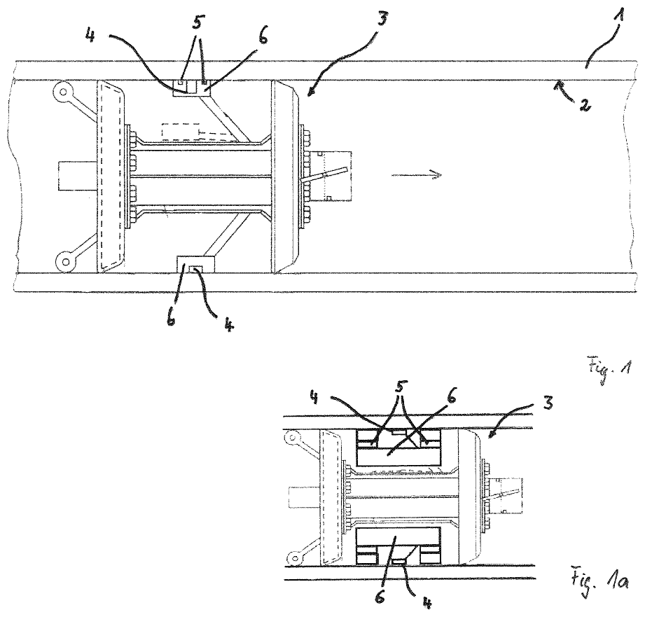

FIG. 1 shows a pipeline 1 to be examined with an inner side of the wall 2, along which the device 3—here in the form of a pig—is guided through the pipeline 1. The measuring units 4 each generate a magnetic field with at least one magnet 5 arranged in the corresponding measuring unit 4, via which they are held on the surface of the inside of the wall 2. The magnets 5 are arranged on a magnetizing device 6, which in the example is designed as a magnet yoke and is guided along the inside of the wall 2 for measuring purposes. From its illustrated first position, the magnetizing device 6, which is pivotably arranged on the remaining device 3, can pivot or be pivoted into a second position (illustrated with dashed lines).

The magnetic field generated by the measuring unit 4 generates an attractive force directed towards the surface of the wall 2 of the pipeline 1 to be measured. This attractive force keeps the measuring units 4 pressed against the inside of the pipeline 1. The device 1 is moved through the pipeline 1 in the direction of the arrow in order to measure properties of the wall 2 with the measuring units 4. In order to reduce the frictional forces with which the measuring units 4 are moved over the surface of the pipeline 1, the measuring units 4 have a compensation unit 9 with which a counterforce is generated on the measuring unit 4, which is opposite to the magnetic attractive force of the permanent magnets e 5.

FIG. 1a shows an enlarged view of the zone in which the magnetizing device 6 with the measuring unit 4 is located. In contrast to the merely sketched representation in FIG. 1, the magnetic yoke in the magnetizing device 6 shown in FIG. 1a is larger.

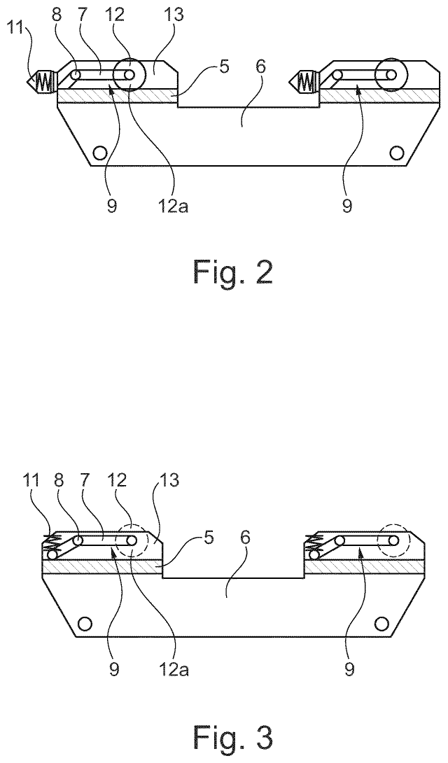

FIG. 2 shows an example of a compensation unit 9. The compensation unit 9 has an adjustment unit 7, which is pivotably mounted on a rotation axis 8, in particular on the magnetizing device 6. While a support roller 12a is mounted at a first end of the adjustment unit 7 as an embodiment example of a support device 12, a power accumulator 11—in the embodiment example in the form of a mechanical spring—engages at the opposite end of the adjustment unit 7, via whose restoring force, built up by a compression movement, the compensation unit 9 supports the device 3, in particular the magnetizing device 6, against the acting magnetic force. The adjustment unit 7, which can be mounted on a rotation axis 8 and which is in any case movably supported on the power accumulator 11, forms a compensation unit 9 with the power accumulator 11, which is connected to the support device 12 attached to the adjustment unit 7.

On its side facing the wall 2, the magnetizing device 6 in the embodiment shown has a brush 13. Since the support roller 12a protrudes beyond the circumferential shape of the brush 13 in the direction of the wall 2 to be examined, the support roller 12a would press the arm of the adjustment unit 7 connected to it below the wall-side upper edge of the brush 13 if the measuring unit 4 with the brush 13 rests against the wall 2 of the pipeline 1 if it is attracted to it by the magnetic force of the permanent magnet 5. However, if the arm of the adjustment unit 7 provided with the support roller 12a is pressed downwards, the opposite arm of the adjustment unit 7 moves upwards around the rotation axis 8, wherein the mechanical spring of the power accumulator 11 is extended. The mechanical spring extended from the rest position, generates a torque around the rotation axis 8 as a counterforce during the extension movement, which counteracts the attractive force of the permanent magnet 5. In this way, the contact pressure with which the magnetizing device 6 is held on the wall 2 is reduced.

FIG. 3 shows a modified embodiment in which the force of the power accumulator 11 does not act on the wall 2 in a lateral direction, but in a vertical direction. If the part of the adjustment unit 7 provided with the support roller 12a is pressed in, the arm opposite the rotation axis 8 compresses the power accumulator 11, which creates the counterforce.

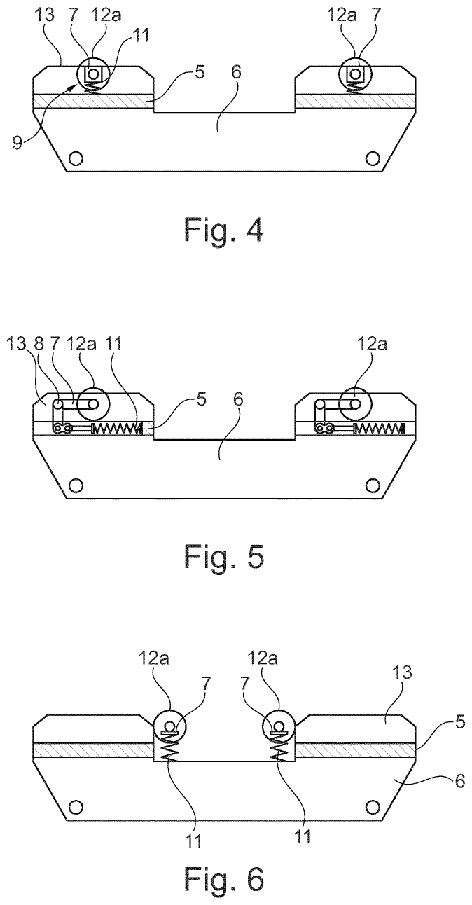

In FIG. 4, the support roller 12a is mounted in the adjustment unit 7, which in turn is mounted on a spring assembly as power accumulator 11. If the support rollers 12a are pressed downwards, the spring assemblies of the power accumulators 11 generate a counterforce to the magnetic force from the permanent magnet 5 during a deflection movement. This design does not require a rotation axis around which the adjustment unit swivels. Instead, the adjustment unit 7 is pressed directly into the power accumulator 11 during a deflection movement of the support device 12.

FIG. 5 shows a toggle linkage in which the pressing force with which the support roller 12a is pressed downwards is transmitted to the power accumulator 11, which generates the counterforce against the magnetic force.

In the embodiment shown in FIG. 6, the support rollers 12a are located next to the brushes 13. However, they are each mounted with the adjustment unit 7 as a bearing on a compression spring as a power accumulator 11.

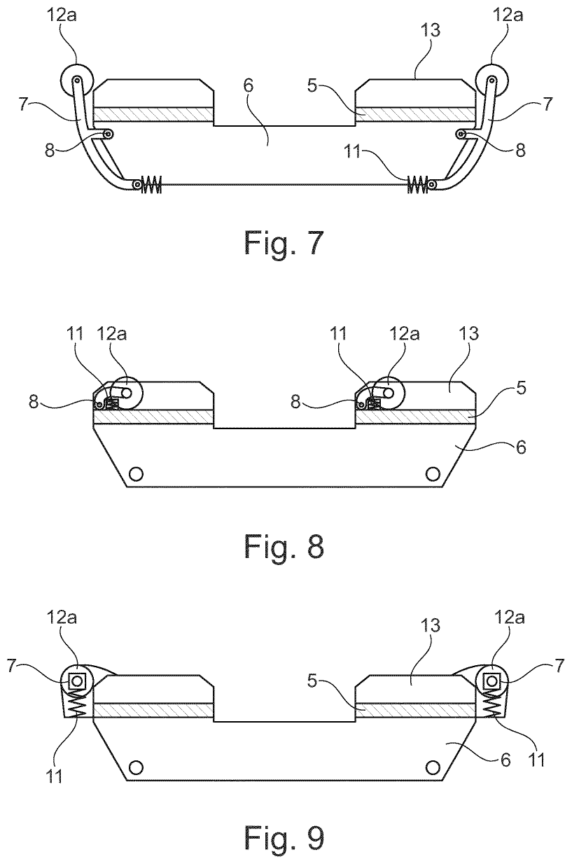

In FIG. 7, the adjustment units 7 are arranged to the side of the magnetizing device 6. The rotation axis 8 is arranged in a fixed position on the magnetizing device 6. The adjustment units 7 rotate as rocker arms around the respective rotation axis 8 if the associated support roller 12a is pressed downwards. During a tilting movement, the end of the adjustment unit 7 facing away from the support roller 12a is pressed against the power accumulator 11, in which a counterforce builds up.

FIG. 8 shows an embodiment example in which a support roller 12a is located at one end of the adjustment unit 7 and the rotation axis 8 is located at the other end. The power accumulator 11 is arranged between the support roller 12a and the rotation axis 8. During a deflection movement of the adjustment unit 7, the power accumulator 11 is compressed, generating the counterforce.

In FIG. 9, the support rollers 12a are arranged at opposite ends of the magnetizing device 6. The support rollers 12a are each mounted in an adjustment unit 7, which in turn is supported on a power accumulator 11. If the support rollers 12a are pressed downwards, the power accumulators 11 are compressed, generating the counterforce.

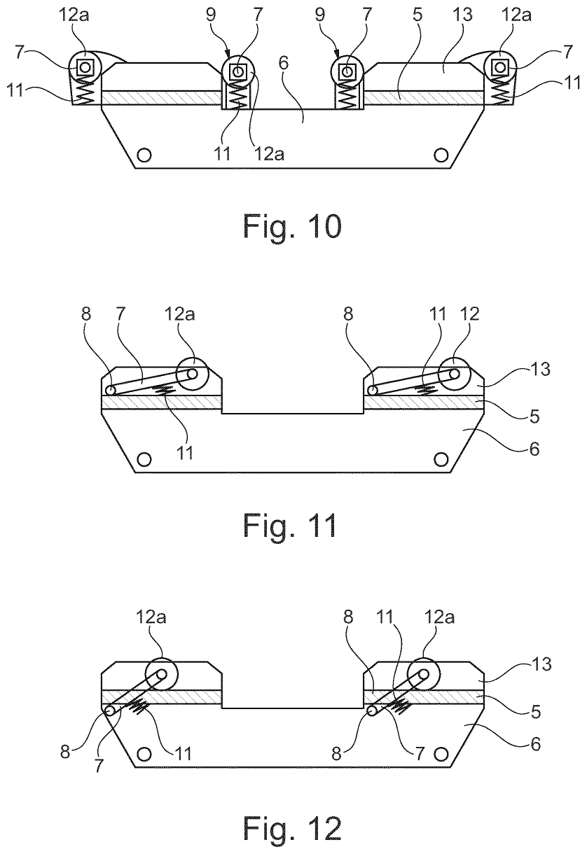

The embodiment shown in FIG. 10 corresponds to the embodiment shown in FIG. 9, but two further compensation units 9 are arranged in the central area of the magnetizing device 6, with which additional counterforces can be generated.

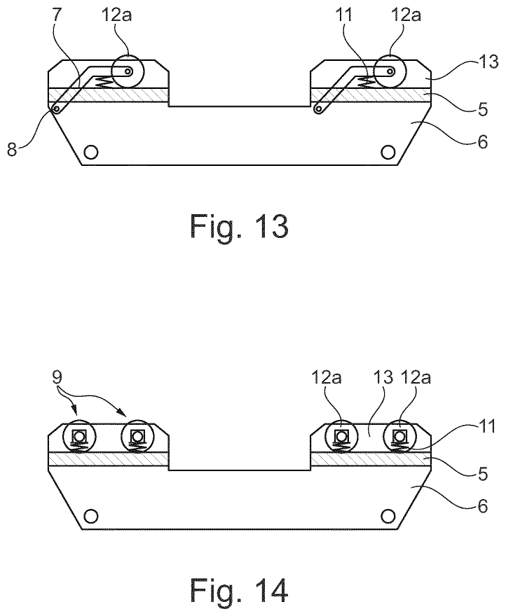

FIGS. 11, 12 and 13 each show a modified embodiment of the embodiment in FIG. 8, wherein the rotation axes 8 are arranged at different positions and the adjustment units 7 are of different lengths or have a different shape.

FIG. 14 shows an embodiment with four compensation units 9, two of which are arranged in the area of a brush 13.

### LIST OF REFERENCE SYMBOLS

1 Pipeline
2 Wall
3 Device
4 Measuring unit
5 Permanent magnet
6 Magnetizing device
7 Adjustment unit
8 Rotation axis
9 Compensation unit
11 Power accumulator
12 Support device
13 Brush

1. A device for the non-destructive testing of pipelines, the device comprising:
at least one measuring unit for recording measured values of the pipeline, the measuring unit having at least one magnet which generates attractive forces between the magnetizing device and a wall of the pipeline,
wherein a magnetizing device is connected to a support device which supports the magnetizing device against the wall of the pipeline, and
wherein the device is adapted to move along the pipeline; and
a compensation unit which movably connects the support device to the magnetizing device via an adjustment unit, wherein the adjustment unit is supported on the device via a power accumulator.

2. The device according to claim 1, wherein the support device has at least one support roller.

3. The device according to claim 1, wherein a counterforce generated by the compensation unit is variable.

4. The device according to claim 3, wherein the compensation unit is supported via one mechanical spring as power accumulator.

5. The device according to claim 3, wherein the compensation unit is supported via a pneumatic cylinder as a power accumulator.

6. The device according to claim 3, wherein the compensation unit is supported via a support drive as a power accumulator.

7. The device according to claim 3, wherein the counterforce generated by the compensation unit is adjustable.

8. The device according to claim 1, wherein the compensation unit is connected to an electrical control unit via which the counterforce can be adjusted.

9. The device according to claim 1, wherein a plurality of compensation units are arranged on a magnetizing device, wherein the support devices are arranged at a distance from one another in the direction of movement of the device.

10. The device according to claim 1, wherein the at least one magnet is a permanent magnet.

11. The device according to claim 1, wherein the at least one magnet is arranged in the magnetizing device.
